(19) United States
(12) Patent Application Publication
(10) Pub. No.: US 2018/0060852 A1
(43) Pub. Date: Mar. 1, 2018

(54) PRINTER AND MERCHANDISE INFORMATION PROCESSING APPARATUS

(71) Applicant: TOSHIBA TEC KABUSHIKI KAISHA, Tokyo (JP)

(72) Inventors: Kenji EOKA, Singapore Singapore (MY); In Seng Ooi, Singapore Singapore (MY); Ting Yee Chin, Singapore Singapore (MY); Wui Khen Kevin Liaw, Singapore Singapore (MY); Tsuyoshi Sanada, Susono Shizuoka (JP)

(21) Appl. No.: 15/684,749

(22) Filed: Aug. 23, 2017

(30) Foreign Application Priority Data
Sep. 1, 2016 (JP) 2016-170595

(51) Int. Cl. G06Q 20/20; B41J 13/00; G06K 15/00; G07G 5/00; B65H 35/06

(52) U.S. Cl. CPC G06Q 20/209; B41J 13/0009; G06K 15/4085; B65H 2601/255; G07G 5/00; B65H 35/06; G06K 15/403

(57) ABSTRACT

A printer according to an embodiment includes a printing unit that prints on a sheet. The sheet is discharged through an outlet. The sheet is conveyed on a sheet conveyance path through the printing unit and to the outlet. A movable device is located on the sheet conveyance path upstream of the outlet in a sheet conveying direction. The movable device can move between a separation position, a proximity position, and a protruding position. A detection device detects a position of the movable device. A controller determines a conveyance abnormality of the sheet based on the state of the movable device detected by the detection device, and outputs a signal indicating the conveyance abnormality.

### CROSS-REFERENCE TO RELATED APPLICATION

This application is based upon and claims the benefit of priority from Japanese Patent Application No. 2016-170595, filed Sep. 1, 2016, the entire contents of which are incorporated herein by reference.

### FIELD

Embodiments described herein relate generally to a printer and a merchandise information processing apparatus.

### BACKGROUND

A merchandise information processing apparatus (for example, a point of sales (POS) terminal) is usually equipped with a printer that prints information about, for example, transaction details on a receipt or journal. The printer prints the information on a sheet conveyed from, for example, a roll of paper, and then conveys the sheet having the information printed thereon to an outlet.

A printer is complicated in structure and is thus vulnerable to the occurrence of an abnormality, such as paper jam, during conveyance of sheets (hereinafter referred to as a “conveyance abnormality”). If the detection of the conveyance abnormality is late and the printer continues operating with the conveyance abnormality unresolved, the printer may fall into an irreparable condition. Therefore, it is desirable that the conveyance abnormality be detected in an early stage.

### DESCRIPTION OF THE DRAWINGS

FIG. 1 is a perspective view illustrating a merchandise information processing apparatus equipped with a printer according to an embodiment.

FIG. 2 is a perspective view of the printer.

FIG. 3 is a block diagram of the printer.

FIG. 4 is a functional block diagram of a control unit of the printer.

FIG. 5 is a diagram illustrating an internal structure of the printer.

FIG. 6 is an enlarged view of the vicinity of an outlet when a movable unit is in a protruding state.

FIG. 7A is a diagram of a guide as viewed from a direction A1 illustrated in FIG. 6.

FIG. 7B is a diagram illustrating a modification example of the guide as viewed from the direction A1.

FIG. 8A is a diagram of the guide as viewed from a direction A2 illustrated in FIG. 6.

FIG. 8B is a diagram of the guide as viewed from the direction A2, illustrating a condition in which the movable unit is located at the guide.

FIG. 9 is an enlarged view of the vicinity of the outlet when the movable unit is in a proximity state.

FIG. 10 is an enlarged view of the vicinity of the outlet when the movable unit is in a separation state.

FIG. 11 is a flowchart of a print processing.

FIG. 12 is an enlarged view of the vicinity of the outlet, illustrating a modification example of a location of the movable unit.

FIG. 13A is a diagram of the guide as viewed from the direction A2 illustrating the modification example of the location of the movable unit.

FIG. 13B is a diagram of the guide as viewed from a direction A2 illustrating a condition in which a sheet is situated between the movable unit and the guide.

FIG. 14 is an enlarged view of the vicinity of the outlet, illustrating another modification example of the movable unit.

### DETAILED DESCRIPTION

Embodiments enable detecting of the conveyance abnormality of a sheet at an early stage.

A printer according to an embodiment includes a printing unit that prints on a sheet. The sheet is discharged through an outlet. The sheet is conveyed on a sheet conveyance path through the printing unit and to the outlet. A movable device is located on the sheet conveyance path upstream of the outlet in a sheet conveying direction. The movable device can move to a separation position in which the sheet causes the movable device to be separated, by more than a predetermined threshold distance, from a conveyance surface on a side of the sheet conveyance path opposite of the movable device. The movable device can move to a proximity position in which the sheet conveyed on the conveyance path causes the movable device to be within the predetermined threshold distance from the conveyance surface. The movable device can move to a protruding position in which a part of the movable device protrudes beyond the conveyance surface toward an opposite side thereof when the sheet is not conveyed on the conveyance path at the position of the movable device. A detection device detects a position of the movable device. A controller determines a conveyance abnormality of the sheet based on the state of the movable device detected by the detection device, and outputs a signal indicating the conveyance abnormality.

Hereinafter, illustrative embodiments will be described with reference to the drawings. Furthermore, in the drawings, the same or similar components are assigned the respective same reference characters.

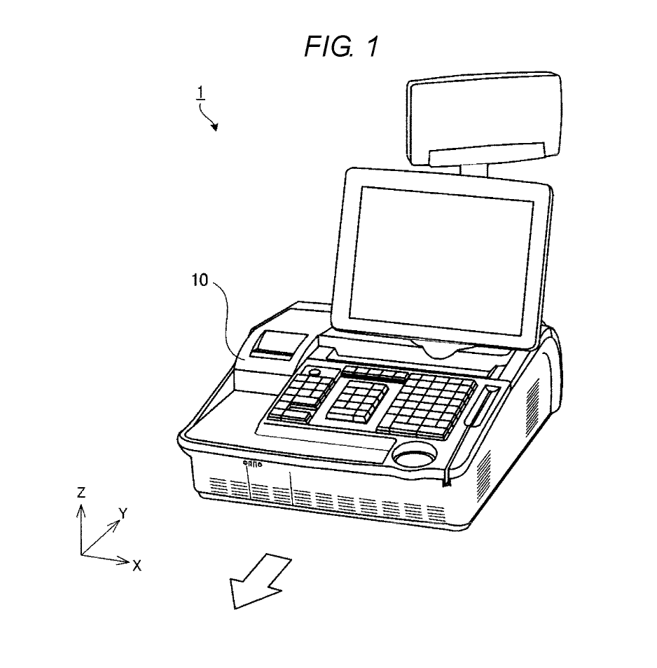

FIG. 1 is a perspective view illustrating a merchandise information processing apparatus 1 equipped with a printer 10 according to an embodiment. The merchandise information processing apparatus 1 is, for example, a point of sales (POS) terminal. The merchandise information processing apparatus 1 is installed at each store and is operated by an operator. The merchandise information processing apparatus 1 is connected to a store server (POS server) (not illustrated) via a network. The printer 10 is connected to or incorporated in the merchandise information processing apparatus 1.

Furthermore, in the following description, an orthogonal coordinate system with an X-axis, a Y-axis, and a Z-axis is used. In the reference coordinate axes, the direction indicated by an arrow is a positive direction. For example, in FIG. 1, the X-axis positive direction is the rightward direction, and the X-axis negative direction is the leftward direction. Moreover, the Y-axis positive direction is the rearward direction, and the Y-axis negative direction is the frontward direction (forward). Additionally, the Z-axis positive direction is the upward direction, and the Z-axis negative direction is the downward direction. The front refers to the side on which the operator is situated. In the example illustrated in FIG. 1, the frontward direction is a direction indicated by an unfilled arrow.

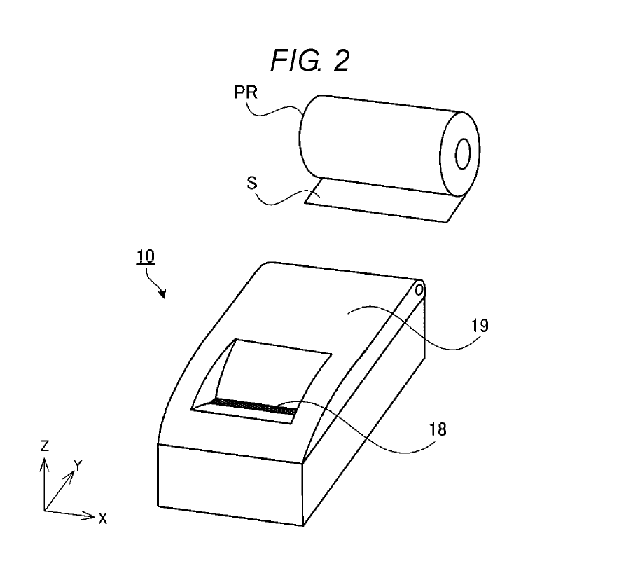

FIG. 2 illustrates the printer 10 separate from the merchandise information processing apparatus 1. The printer 10 is a receipt printer used to issue a receipt. The printer 10 is equipped with a cover 19 at an upper portion thereof, and is able to load a roll of paper PR in the interior thereof. The roll of paper PR is a roll-shaped printing medium in which a sheet S is rolled. The printer 10 extracts the sheet S from the roll of paper PR and prints information about, for example, transaction details on the sheet S. The printer 10 includes an outlet 18 through which the sheet S is discharged. While, in the example illustrated in FIG. 2, the outlet 18 opens in the upward direction, the outlet 18 can also open in the frontward direction. Furthermore, the appearances illustrated in FIG. 1 and FIG. 2 are merely examples, and can be modified in various manners.

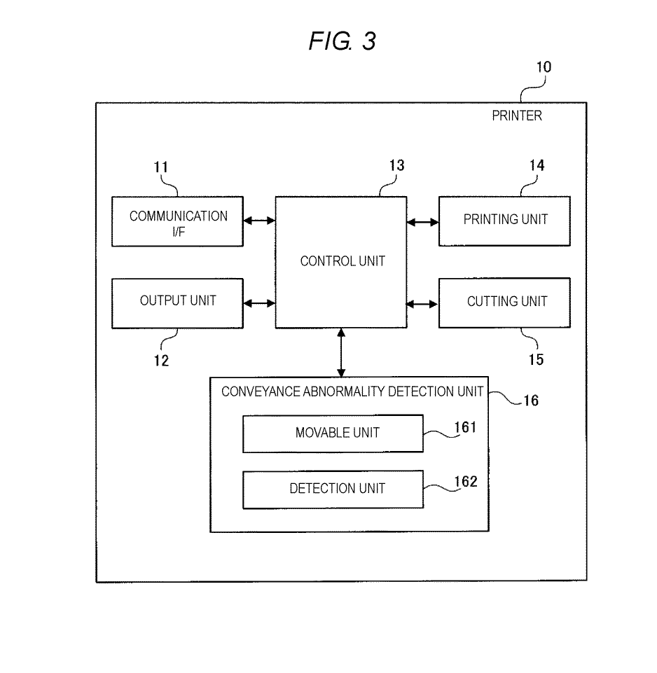

FIG. 3 is a block diagram of the printer 10. The printer 10 includes a communication interface 11, an output unit 12, a control unit 13, a printing unit 14, a cutting unit 15, and a conveyance abnormality detection unit 16.

The communication interface 11 communicates with a control device (for example, a processor) of the merchandise information processing apparatus 1. The communication interface 11 acquires various pieces of data from the merchandise information processing apparatus 1. Data which the communication interface 11 acquires from the merchandise information processing apparatus 1 includes information which the printing unit 14 prints on the sheet S (for example, transaction details). Furthermore, in the following description, information which the printing unit 14 prints on a receipt is referred to as “print data”.

The output unit 12 is an output device used to inform the user of information. The output unit 12 is, for example, a sound-producing apparatus, such as a loudspeaker or a buzzer. The output unit 12 can also be a display device, such as a liquid crystal display or an organic electroluminescence (EL) display. The output unit 12 informs the user of the occurrence of an abnormality, such as the occurrence of a conveyance abnormality.

The control unit 13 is includes a processing device such as a processor. The control unit 13 functions as a control device that controls each unit of the printer 10. The control unit 13 may have a single processor or a plurality of processors. In a case where the control unit 13 includes a plurality of processors, the plurality of processors may be arranged at different locations inside the printer 10 (for example, on different substrates). The control unit 13 operates according to a program stored in a read-only memory (ROM) or a random access memory (RAM) inside the control unit 13 or outside the control unit 13, thus implementing various operations including reading processing, which is described below. Furthermore, the program may be a microprogram using microcode.

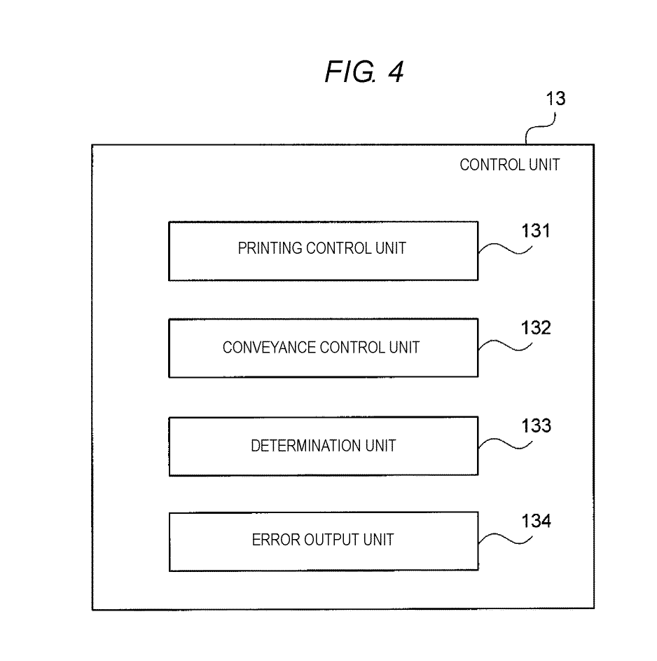

FIG. 4 is a functional block diagram of the control unit 13. The control unit 13 may be programmed to function as a printing control unit 131, a conveyance control unit 132, a determination unit 133, and an error output unit 134. These functional blocks (the printing control unit 131, the conveyance control unit 132, the determination unit 133, and the error output unit 134) can be software blocks or can be hardware blocks. For example, each block illustrated in FIG. 4 can be a single piece of hardware (for example, a single processor or a single circuit block on a semiconductor chip). Further, each block can be implemented by a cooperation of a plurality of processors. Moreover, the control unit 13 may be configured with a single processor and each block may be implemented by software (including a microprogram). Even in a case where each block is implemented by software, the control unit 13 may be configured with a plurality of processors. The printing control unit 131 functions as a printing control unit of the printer 10, and the conveyance control unit 132 functions as a conveyance control unit of the printer 10. Moreover, the determination unit 133 functions as a determination unit of the printer 10, and the error output unit 134 functions as an error output unit of the printer 10.

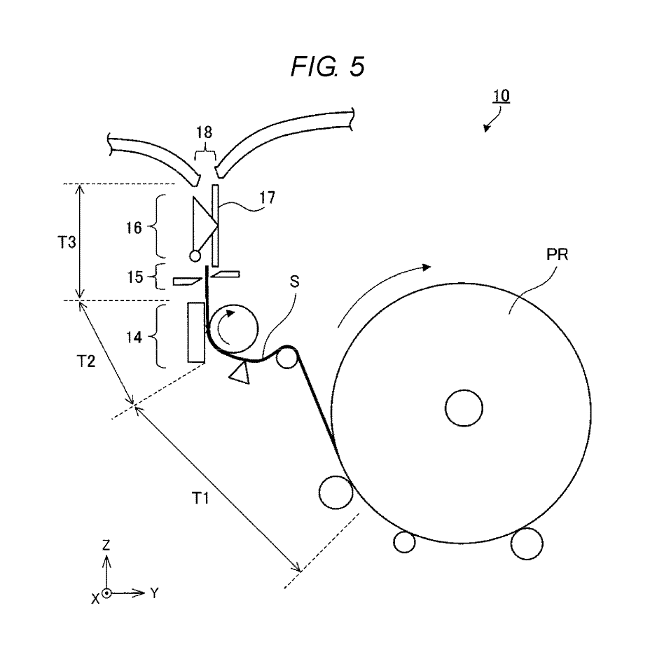

FIG. 5 is a diagram illustrating an internal structure of the printer 10. The printer 10 is configured to allow the roll of paper PR to be attached thereto and detached therefrom. The sheet S extracted from the roll of paper PR passes through conveyance paths T1 to T3 and is then discharged from the outlet 18. The conveyance path T1 is a pathway used until the sheet S arrives at the printing unit 14. The printing unit 14 is located on the conveyance path T2. The conveyance path T3 is a pathway between the printing unit 14 and the outlet 18. The conveyance paths T1 to T3 can be pathways formed by sheet guides and rollers. In the printer 10, the printing unit 14, the cutting unit 15, and the conveyance abnormality detection unit 16 are arranged along the conveyance paths. In the conveyance path T3, a guide 17 is positioned as a sheet guide that guides the sheet S to the outlet 18.

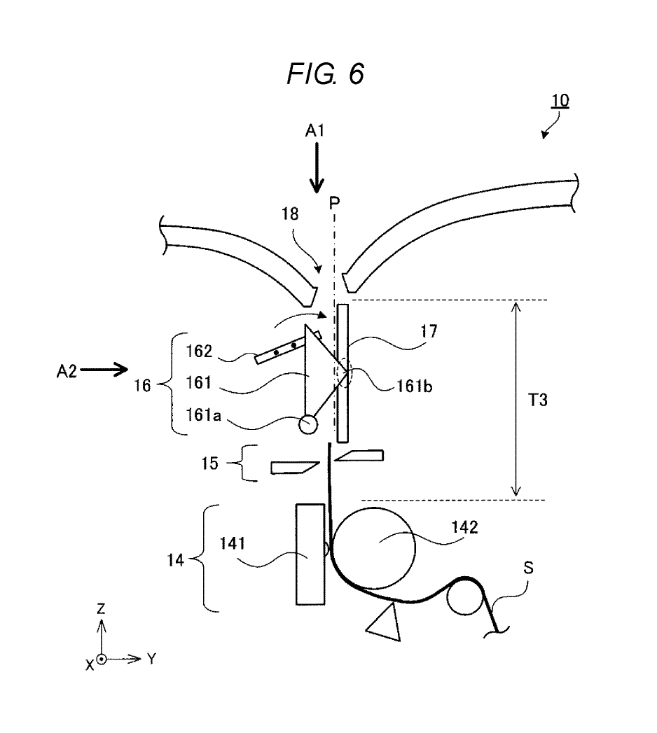

The printing unit 14 prints various pieces of information, such as transaction details, on the sheet S. The printing unit 14 may be a thermal-type print unit. The printing unit 14 includes a print head 141 and a roller 142 (for both see FIG. 6). The print head 141 is a thermal head, and the roller 142 is a platen roller. The roller 142 also serves as a conveyance unit that conveys the sheet S. The printing unit 14 prints information, such as transaction details, on the sheet S according to control performed by the control unit 13.

The cutting unit 15 is a cutter used to cut off a printing-completed portion (for example, a portion serving as a receipt) from the sheet S. The cutting unit 15 can be a slide-type cutter or a roller-type cutter. In FIG. 5, a slide-type cutter is illustrated as an example of the cutting unit 15. Naturally, the configuration of the cutting unit 15 is not limited to this, but can be modified in various manners. Furthermore, in FIG. 5, the cutting unit 15 is provided on the upstream side of the conveyance abnormality detection unit 16 (in other words, between the printing unit 14 and the conveyance abnormality detection unit 16); however, the cutting unit 15 may be provided on the downstream side of the conveyance abnormality detection unit 16 (in other words, between the conveyance abnormality detection unit 16 and the outlet 18).

The conveyance abnormality detection unit 16 is a detection device that detects whether a conveyance abnormality of the sheet S has occurred in the conveyance path T3. The conveyance abnormality detection unit 16 is a sensor that detects, for example, the presence or absence of the sheet S and the thickness of the sheet S in the conveyance path. Here, the conveyance abnormality refers to the sheet S not being conveyed in a normal way inside the conveyance path. The conveyance abnormality is typically paper jam, but is not limited to paper jam. The conveyance abnormality can include a case where the sheet S is unable to be conveyed due to, for example, runout of paper, wrinkles on paper, slack of paper, or failed loading of the roll of paper PR. The conveyance abnormality detection unit 16 is located between the printing unit 14 and the outlet 18 (in other words, in the conveyance path T3).

FIG. 6 is an enlarged view of the vicinity of the conveyance abnormality detection unit 16 of the printer 10. The conveyance abnormality detection unit 16 can be a mechanical sensor or can be an optical sensor. In FIG. 6, an actuator and sensor arrangement is illustrated as an example of the conveyance abnormality detection unit 16.

The conveyance abnormality detection unit 16 includes a movable unit 161 and a detection unit 162. The movable unit 161 is a movable device, such as a rotating body, which rotates around a rotating shaft 161a. The axial direction of the rotating shaft 161a is a direction parallel to a conveyance surface P for the sheet S and perpendicular to the conveyance direction of the sheet S (in the case of the present embodiment, the X-axis direction). While, in the present embodiment, the movable unit 161 is a rotating body in the shape of a triangle plate, the configuration of the movable unit 161 is not limited to this. The movable unit 161 is located with one vertex of the triangle facing the conveyance path T3.

As mentioned above, the guide 17, which guides the sheet S to the outlet 18, is located in the conveyance path T3. The shape of the guide 17 can be optionally modified. In the present embodiment, as an example, the guide 17 is a plate-like sheet guide. The guide 17 is located in such a manner that a planar surface portion of the plate faces the sheet S. The movable unit 161 is located in such a way as to face the guide 17 across the conveyance surface P. Here, the conveyance surface P refers to a surface that guides the forward movement of the sheet S.

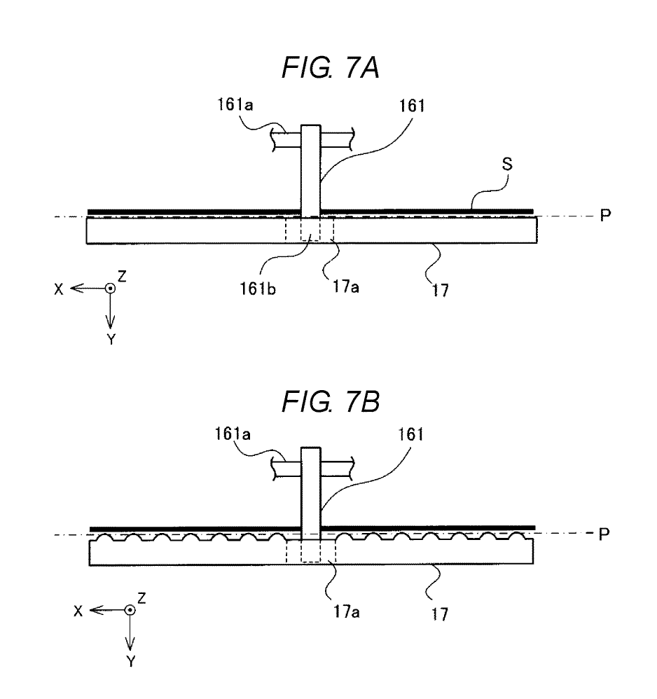

FIG. 7A is a diagram illustrating the movable unit 161 and the guide 17 as viewed from a direction A1 illustrated in FIG. 6. More specifically, FIG. 7A is a diagram illustrating the movable unit 161 and the guide 17 as viewed in the direction of the conveyance path T3 from the position of the outlet 18 (in the case of the present embodiment, looking towards the Z-axis negative direction). In the guide 17, a region used to face the sheet S (hereinafter referred to as a “guide region”) is formed as a planar surface portion. Therefore, in the example illustrated in FIG. 7A, the planar surface portion of the guide 17 itself serves as the conveyance surface P. Furthermore, the guide region does not necessarily need to be a planar surface. For example, the guide region can be in the shape of a patterned raised and recessed surface as illustrated in FIG. 7B. In this case, a surface formed by connecting protruding portions (points, lines, or surfaces) facing the sheet S serves as the conveyance surface P. The conveyance surface P is not limited to a planar surface, but can be a curved surface.

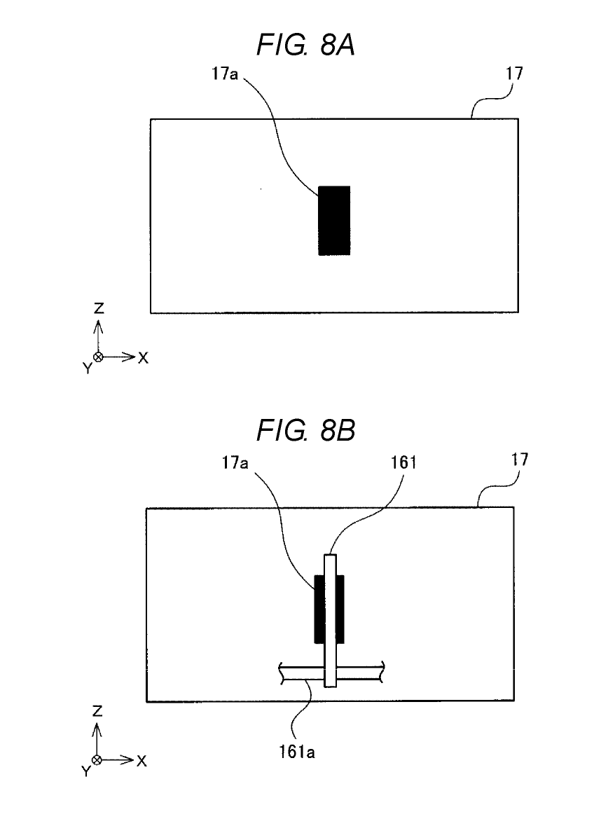

FIG. 8A is a diagram illustrating the guide 17 as viewed from a direction A2 illustrated in FIG. 6. More specifically, FIG. 8A is a diagram illustrating the guide 17 as viewed in the horizontal direction from the front side of the printer 10. An insertion receiving portion 17a, into which a part of the movable unit 161 may be inserted, is formed at the guide region of the guide 17. The insertion receiving portion 17a maybe a through-hole or a recessed portion. The movable unit 161 is located at a position opposite to the insertion receiving portion 17a as illustrated in FIG. 8B.

As mentioned above, the movable unit 161 rotates around the rotating shaft 161a. When rotating around the rotating shaft 161a, the movable unit 161 reciprocates in a direction to separate from the conveyance surface P (in the case of the example illustrated in FIG. 6, the Y-axis negative direction) and a direction towards the conveyance surface P (in the case of the example illustrated in FIG. 6, the Y-axis positive direction). An urging force is applied to the movable unit 161 in a direction towards the guide 17. Referring to the example illustrated in FIG. 6, an urging force is applied to the movable unit 161 so that the movable unit 161 rotates clockwise, in FIG. 6, around the rotating shaft 161a. The urging force can be a spring force or can be a magnetic force.

During non-passage of the sheet S, the urging force causes a part of the movable unit 161 to protrude beyond the conveyance surface P toward the opposite side thereof (the Y-axis positive direction side) as illustrated in FIG. 7A. Furthermore, in the following description, such a protruding portion (161b illustrated in FIG. 7A) is referred to as a “protrusion”. Moreover, in the following description, a state in which the protrusion 161b is protruding is referred to as a “protruding state”, and a state in which the protrusion 161b is not protruding is referred to as a “non-protruding state”.

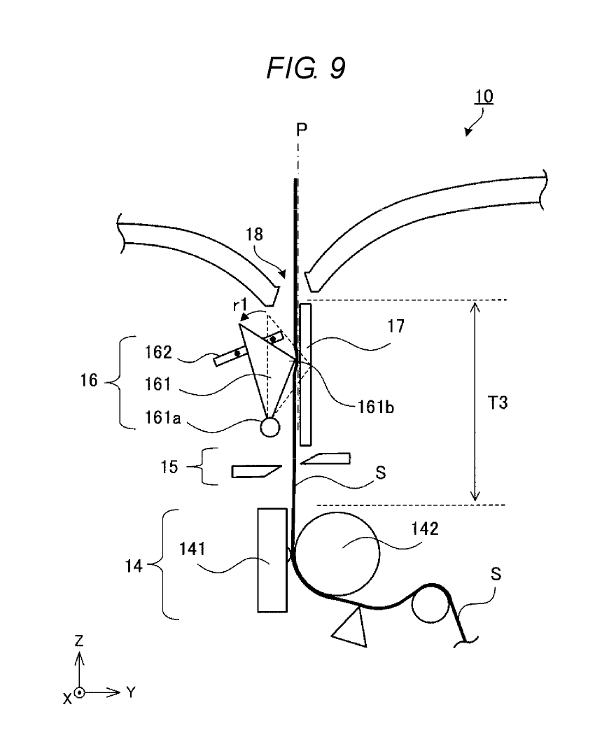

FIG. 9 illustrates a state of the movable unit 161 taken when the sheet S is situated between the movable unit 161 and the conveyance surface P, in a normal state. The normal state refers to a state in which the sheet S is being conveyed through the conveyance path without any conveyance abnormality, such as paper jam. When the sheet S passes between the movable unit 161 and the conveyance surface P, the movable unit 161 is pushed by the sheet S to rotate counterclockwise, in FIG. 9, around the rotating shaft 161a by an angle r1. With this, the protrusion 161b of the movable unit 161 enters a state in which the protrusion 161b is in proximity to the conveyance surface P. In the following description, the state in which the protrusion 161b is in proximity to the conveyance surface P is referred to as a “proximity state”. The proximity state is one of non-protruding states. Furthermore, even a state in which the protrusion 161b is somewhat protruding from the conveyance surface P due to flexure of the sheet S can be regarded as a state in which the movable unit 161 is in the non-protruding state (and the proximity state). Moreover, even a state in which the protrusion 161b is somewhat separate from the conveyance surface P due to the thickness or small wrinkles of the sheet S can be regarded as a state in which the movable unit 161 is in the proximity state.

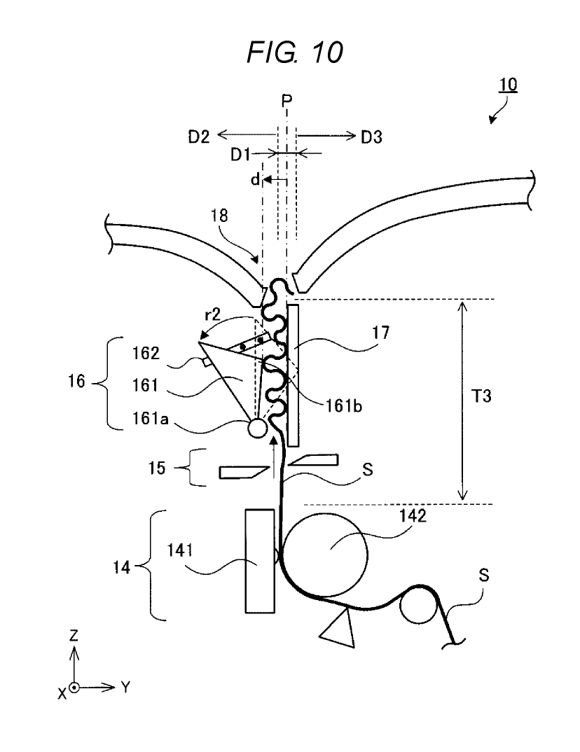

FIG. 10 illustrates a state of the movable unit 161 taken when the sheet S is situated between the movable unit 161 and the conveyance surface P in a paper jam state. The sheet S jammed in the vicinity of the outlet 18. In this case, the movable unit 161 is pushed by the sheet S to rotate counterclockwise, in FIG. 10, around the rotating shaft 161a by an angle r2. The angle r2 is greater than the angle r1. Accordingly, the protrusion 161b of the movable unit 161 enters a state in which the protrusion 161b is separate from the conveyance surface P. In the following description, the state in which the protrusion 161b is separate from the conveyance surface P is referred to as a “separation state”. The separation state is one of non-protruding states. The position of the movable unit 161 in the protruding state may be referred to as a protruding position. Further, he position of the movable unit 161 in the proximity state maybe referred to as a proximity position. Further, the position of the movable unit 161 in the separation state may be referred to as a separation position.

What state of the movable unit 161 is deemed as the protruding state, the proximity state, or the separation state can be set by the apparatus designer as appropriate. For example, in a case where the distance from the conveyance surface P to a tip of the protrusion 161b (hereinafter referred to as a “separation amount d”) falls within a predetermined range (for example, in a case where the tip of the protrusion 161b is present in a range D1 illustrated in FIG. 10), the movable unit 161 is determined to be in the proximity state. Moreover, in a case where the separation amount d exceeds a predetermined amount toward the non-protruding side (the Y-axis negative direction side) (for example, in a case where the tip of the protrusion 161b is present in a range D2 illustrated in FIG. 10), the movable unit 161 is determined to be in the separation state. Additionally, in a case where the separation amount d exceeds a predetermined amount toward the protruding side (the Y-axis positive direction side) (for example, in a case where the tip of the protrusion 161b is present in a range D3 illustrated in FIG. 10), the movable unit 161 is determined to be in the protruding state. The separation amount (threshold value), which is used to distinguish between the protruding state, the proximity state, and the separation state, can be set as appropriate by the apparatus designer.

The detection unit 162 is a detection device such as a sensor that detects the state of the movable unit 161. The detection unit 162 is, for example, a photosensor. In FIG. 6, FIG. 9, and FIG. 10, a rod-like sensor having a plurality of sensors (filled circles in these figures) is illustrated as an example of the detection unit 162. The plurality of sensors is arranged along the rotational direction of the movable unit 161. Each of the plurality of sensors is able to detect light. A light source (not illustrated) is located at the opposite side of the plurality of sensors across the movable unit 161. The detection unit 162 detects the state of the movable unit 161 according to whether light is blocked by the movable unit 161. Furthermore, the configuration of the detection unit 162 as described herein is merely an example. Various known configurations can be employed as the detection unit 162 so long as it is able to detect the state of the movable unit 161.

The state of the movable unit 161 which the detection unit 162 detects can be digital information indicating in which state the movable unit 161 is out of the protruding state, the proximity state, and the separation state, or can be analog information indicating the separation amount of the protrusion 161b from the conveyance surface P. A detection result obtained by the detection unit 162 is sent to the control unit 13. The detection result can be an electrical signal (for example, a voltage level indicating the state or separation amount of the movable unit 161), or can be a data signal (for example, a numerical value indicating the state or separation amount of the movable unit 161). The detection unit 162 functions as a detection unit of the printer 10. Each of the plurality of sensors included in the detection unit 162 can be regarded as a detection unit.

Next, an operation of the printer 10 having the above-described configuration is described.

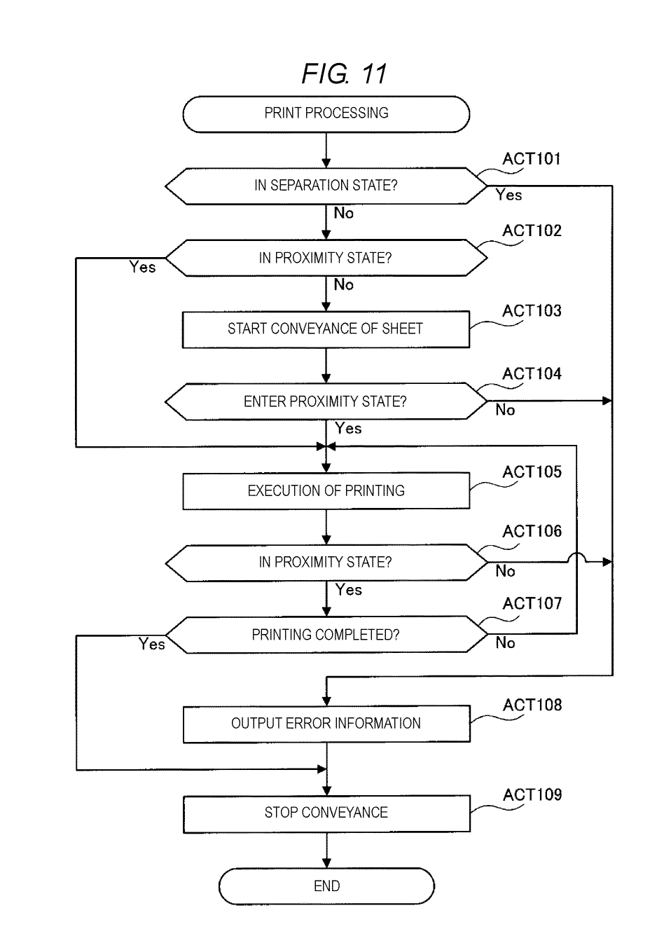

The control unit 13 of the printer 10 starts print processing in response to receiving a printing start instruction from the merchandise information processing apparatus 1. Hereinafter, the print processing is described with reference to the flowchart of FIG. 11.

In step ACT101, the determination unit 133 of the control unit 13 determines whether the movable unit 161 is in the separation state, such as that illustrated in FIG. 10. The determination unit 133 detects the state of the movable unit 161 based on the detection result sent from the detection unit 162.

If the movable unit 161 is in the separation state (YES in step ACT101), the determination unit 133 determines that the conveyance abnormality of the sheet S is occurring between the printing unit 14 and the outlet 18 (in the conveyance path T3), and then proceeds to step ACT108. In step ACT108, the error output unit 134 outputs to the output unit 12 information indicating that the conveyance abnormality is occurring in the conveyance path T3. The error output unit 134 can output such error information to the merchandise information processing apparatus 1 via the communication interface 11. Furthermore, in a case where the conveyance of the sheet S is previously started, then in step ACT109, the conveyance control unit 132 stops the conveyance of the sheet S.

If the movable unit 161 is not in the separation state (NO in step ACT101), then in step ACT102, the determination unit 133 determines whether the movable unit 161 is in the proximity state, such as that illustrated in FIG. 9. As with step ACT101, the determination unit 133 detects the state of the movable unit 161 based on the detection result sent from the detection unit 162. If the movable unit 161 is in the proximity state (YES in step ACT102), since the sheet S is in the normal state, the determination unit 133 proceeds to execution of printing in step ACT105.

If the movable unit 161 is not in the proximity state (NO in step ACT102), since the sheet S is not present between the movable unit 161 and the conveyance surface P, the determination unit 133 is unable to determine whether the sheet S is in the normal state. Therefore, in step ACT103, the conveyance control unit 132 performs the conveyance of the sheet S to bring the sheet S to a space between the movable unit 161 and the conveyance surface P. In such an arrangement, the conveyance control unit 132 controls the roller 142 to convey the sheet S. In a case where the printer 10 has a conveyance roller separately from the roller 142, the conveyance control unit 132 can control the conveyance roller to convey the sheet S. In such an arrangement, the printing control unit 131 can control the print head 141 to start printing at the same time as the start of conveyance.

Then, in step ACT104, the determination unit 133 determines whether the movable unit 161 enters the proximity state within a previously-set time from the start of conveyance. As with step ACT101, the determination unit 133 detects the state of the movable unit 161 based on the detection result sent from the detection unit 162.

If the movable unit 161 does not enter the proximity state (NO in step ACT104), the determination unit 133 determines that the conveyance abnormality is occurring at the printing unit 14 (in the conveyance path T2 illustrated in FIG. 5) or before the sheet S arrives at the printing unit 14 (in the conveyance path T1 illustrated in FIG. 5), and then proceeds to step ACT108. In step ACT108, the error output unit 134 outputs, to the user via the communication interface 11 or the output unit 12, information indicating that the conveyance abnormality is occurring in the conveyance path T1 or T2. Then, in step ACT109, the conveyance control unit 132 stops the conveyance of the sheet S. In order to reduce the expansion of the abnormality, the conveyance control unit 132 can stop the conveyance before the error output unit 134 outputs such error information.

Furthermore, in a case where the movable unit 161 enters the separation state within a previously-set time from the start of conveyance, the determination unit 133 determines that the conveyance abnormality is occurring in the conveyance path T1. In this case, the error output unit 134 also outputs information indicating that the conveyance abnormality is occurring in the conveyance path T1 or T2, and at the same time, the conveyance control unit 132 stops the conveyance of the sheet S.

If the movable unit 161 enters the proximity state (YES in step ACT104), since the sheet S is in the normal state, the printing control unit 131 prints print data on the sheet S. In step ACT105, coordinating with printing performed by the printing control unit 131, the conveyance control unit 132 conveys the sheet S.

Then, in step ACT106, the determination unit 133 determines whether the movable unit 161 is in the proximity state. As with step ACT101, the determination unit 133 detects the state of the movable unit 161 based on the detection result sent from the detection unit 162.

If the movable unit 161 is not in the proximity state, in other words, if the movable unit 161 is in the protruding state or the separation state (NO in step ACT106), the determination unit 133 determines that the conveyance abnormality is occurring during printing. More specifically, if the movable unit 161 enters or remains in the protruding state after starting conveyance, the determination unit 133 determines that runout of paper has occurred or the conveyance abnormality is occurring in the conveyance path T1 or T2. Moreover, if the movable unit 161 enters the separation state, the determination unit 133 determines that the conveyance abnormality is occurring in the conveyance path T3. In step ACT108, the error output unit 134 outputs information indicating the occurrence of the conveyance abnormality. Then, in step ACT109, the conveyance control unit 132 stops the conveyance of the sheet S. The conveyance control unit 132 can stop the conveyance before the error output unit 134 outputs such error information.

If the movable unit 161 is in the proximity state (YES in step ACT106), then in step ACT107, the determination unit 133 determines whether printing is completed. If printing is not completed (NO in step ACT107), the control unit 13 returns to step ACT105. If printing is completed (YES in step ACT107), then in step ACT109, the conveyance control unit 132 stops the conveyance of the sheet S. When the conveyance is stopped, the control unit 13 ends the print processing.

According to the present embodiment, since the printer 10 is equipped with the movable unit 161, the detection unit 162, and the determination unit 133, the user can be notified of the conveyance abnormality of the sheet S at an early stage. In particular, the movable unit 161 is not provided inside a complicated mechanism of the printer 10 (for example, the conveyance path T1 or T2) but rather in the vicinity of the outlet 18 of the printer 10. Therefore, the movable unit 161 is unlikely to hinder the conveyance of the sheet S, and the movable unit 161 is unlikely to cause the conveyance abnormality of the sheet S.

Furthermore, the movable unit 161 is able to move between the protruding state and the proximity state. Therefore, even if the movable unit 161 is not provided at a deep position inside the mechanism, the printer 10 is able to determine whether the conveyance abnormality is occurring inside the mechanism by checking whether the movable unit 161 changes into the proximity state after the start of printing.

The above-described embodiment is merely an example, and can be modified in various manners and applied to various usages.

For example, in the above-described embodiment, the movable unit 161 is located at the side of the conveyance surface P closer to the print head 141 (at the Y-axis negative direction side). In other words, the movable unit 161 is located in such a way as to face a printing surface of the sheet S. However, the movable unit 161 can be located in such a way as to face a non-printing surface of the sheet S. The non-printing surface is a surface of the sheet S on which printing is not performed.

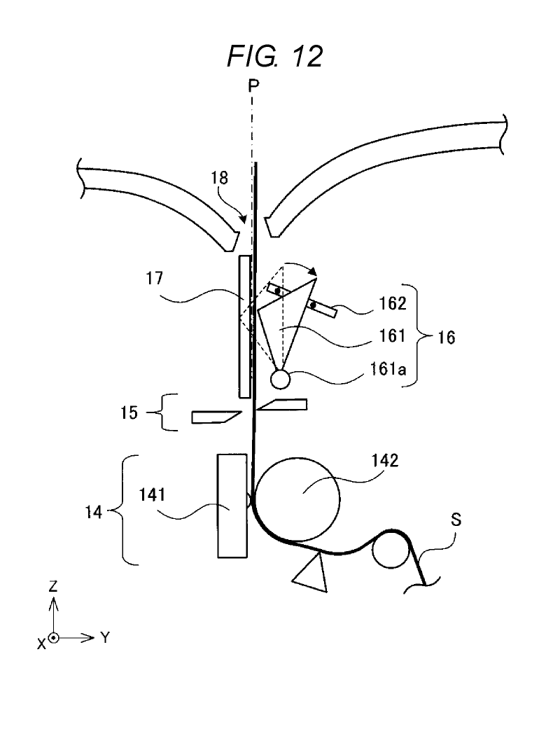

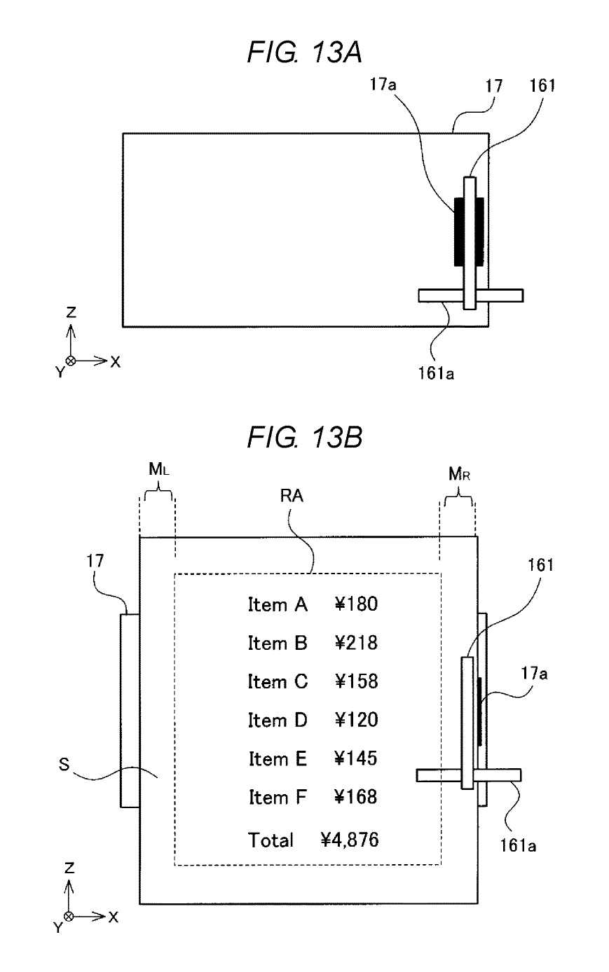

FIG. 12 illustrates an example in which the movable unit 161 is located in such a way as to face the non-printing surface of the sheet S. In the example illustrated in FIG. 12, the movable unit 161 is located at the side of the conveyance surface P closer to the roller 142 (at the Y-axis positive direction side) in such a manner that the movable unit 161 faces a non-printing surface of the sheet S. With this, since the movable unit 161 no longer contacts a recording region of the sheet S, characters printed on the sheet S are unlikely to become illegible due to, for example, friction or pressure from the movable unit 161. For example, in a case where the sheet S is thermal paper, a phenomenon in which a line appears in a printing region due to a pressure from the movable unit 161 can be reduced. The recording region refers to a region excluding the left, right, top, and bottom margin regions in the printing surface of the sheet S. In an example illustrated in FIG. 13B, the recording region is a region RA surrounded by a dashed line in a central portion of the sheet S.

Furthermore, the movable unit 161 can be located in such a way as to face a non-recording region of the printing surface. For example, as illustrated in FIGS. 13A and 13B, the movable unit 161 can be located at the end of the guide 17 in the X-axis direction in such a way as to face a right margin region M_{R} or left margin region M_{L} of the sheet S. Moreover, while, in the example illustrated in FIGS. 13A and 13B, the movable unit 161 is located in such a way as to face the margin region M_{R}, the movable unit 161 can be located in such a way as to face the margin region M_{L}. Additionally, the non-recording region refers to a region excluding the recording region RA in the surfaces of the sheet S. More specifically, the non-recording region refers to a non-printing surface and left, right, top, and bottom margin regions of a printing surface of the sheet S.

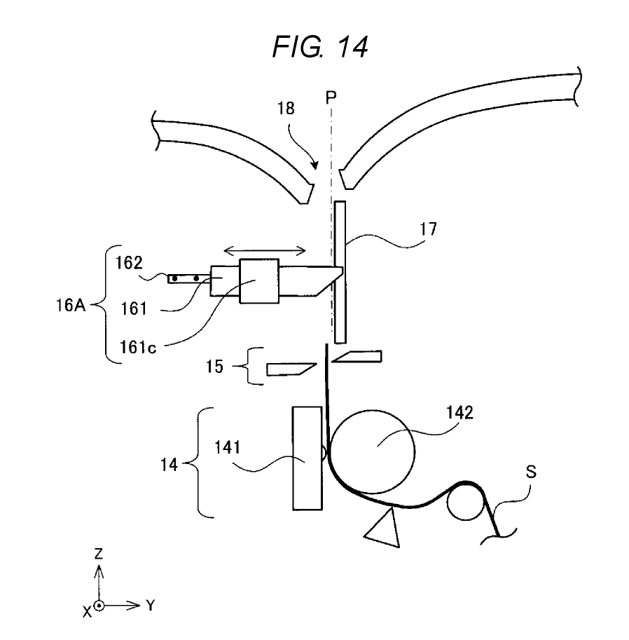

Furthermore, while, in the above-described embodiment, the movable unit 161 is a rotating body, the movable unit 161 is not limited to this. For example, as illustrated in FIG. 14, the movable unit 161 can be a rod-like body, which is inserted into a tubular support member 161c and is linearly movable along the direction generally perpendicular to (or at least away from) the conveyance surface P (the Y-axis direction). In such an arrangement, the detection unit 162 can be configured with a plurality of photosensors each of which detects the state of the movable unit 161 according to whether light is blocked by the rod-like body.

The insertion receiving portion 17a, into which the protrusion 161b of the movable unit 161 is inserted, is a through-hole or a recessed portion. However, the insertion receiving portion 17a is not limited to these. For example, the insertion receiving portion 17a can be a gap between the guide 17 and a chassis of the printer 10. Additionally, the guide 17 may be configured with a plurality of members, and the insertion receiving portion 17a can be a gap between a member and another member.

Furthermore, while, in the above-described embodiment, the movable unit 161 takes three states, i.e., the protruding state, the proximity state, and the separation state, the states which the movable unit 161 takes can be two states out of these states. For example, the movable unit 161 can be configured to take the proximity state and the separation state, or the protruding state and the proximity state. Moreover, while, in the above-described embodiment, the non-protruding state which the movable unit 161 takes includes two states, the separation state and the proximity state, the non-protruding state can be any one of the separation state and the proximity state.

Furthermore, while, in the above-described embodiment, the printing unit 14 is a thermal-type print unit, the printing unit 14 is not limited to the thermal-type print unit. For example, the printing unit 14 can be a dot impact-type, inkjet-type, or electrophotographic-type print unit.

Moreover, while, in the above-described embodiment, the printer 10 is connected to or incorporated in the merchandise information processing apparatus 1, the printer 10 can be configured to be externally attachable to the merchandise information processing apparatus 1. For example, the printer 10 can be equipped with a connection interface, such as Universal Serial Bus (USB), and can be configured to be connectable to the merchandise information processing apparatus 1 via a communication cable, such as a USB cable.

Besides, the printer 10 can be equipped with a user interface and can be configured to be able to operate independently of the merchandise information processing apparatus 1. Additionally, the printer 10 can be connected to a personal computer and can be configured to operate based on a instruction from the personal computer.

Furthermore, while, in the above-described embodiment, the printer 10 is equipped with the output unit 12, the printer 10 does not need to be equipped with the output unit 12. In such an arrangement, the error output unit 134 of the control unit 13 only needs to inform the merchandise information processing apparatus 1 (or another apparatus) of the occurrence of the conveyance abnormality via the communication interface 11.

Moreover, in the above-described embodiment, the merchandise information processing apparatus 1 has a configuration to which the printer 10 is fixed or in which the printer 10 is incorporated. However, the merchandise information processing apparatus 1 can be configured to be able to directly perform printing on the sheet S without involving the printer 10. For example, the merchandise information processing apparatus 1 can include the communication interface 11, the output unit 12, the control unit 13, the printing unit 14, the cutting unit 15, the conveyance abnormality detection unit 16 (the movable unit 161 and the detection unit 162), and the guide 17. The control unit 13 can be used in common with a control device (for example, a processor) which controls each unit of the merchandise information processing apparatus 1. The merchandise information processing apparatus 1 can be regarded as the printer 10 itself.

Furthermore, while, in the above-described embodiment, the merchandise information processing apparatus 1 is a POS terminal, the merchandise information processing apparatus 1 is not limited to the POS terminal. For example, the merchandise information processing apparatus 1 can be a stand-alone type cash register which does not have a network connection function.

Moreover, while, in the above-described embodiment, the printer 10 is installed at a POS terminal or a stand-alone type cash register, the apparatus at which the printer 10 is installed can be another apparatus, such as an automated teller machine (ATM) or an automatic vending machine.

Additionally, while, in the description of the above-described embodiment, the printer 10 is a receipt printer, the printer 10 is not limited to the receipt printer. For example, the printer 10 can be a label printer. In such an arrangement, a roll of paper PR to be stored in the printer 10 can be a roll of paper for label printing in which a label printing sheet is rolled. Naturally, the printer 10 can be a printer other than the receipt printer and the label printer. For example, the printer 10 can be a printer that performs printing on a list of particulars (for example, a bank statement). Moreover, a printing medium on which the printer 10 performs printing is not limited to a continuous sheet such as a roll of paper. For example, the printer 10 can be a printer that performs printing on a non-continuous profile sheet, such as plain paper (for example, A4 size paper or B5 size paper). The non-continuous profile sheet can be photo paper.

A control device that controls the printer 10 or the merchandise information processing apparatus 1 according to the present embodiment can be implemented by a dedicated computer system or can be implemented by an ordinary computer system. For example, the control device can be configured by storing a program for performing the above-described operation in a computer-readable recording medium, such as an optical disc, a semiconductor memory, a magnetic tape, or a flexible disc, distributing the computer-readable recording medium, installing the program on a computer, and performing the above-described processing. In such an arrangement, the control device can be a computer (processor) incorporated in the printer 10 or the merchandise information processing apparatus 1 or can be a computer which externally controls the printer 10 or the merchandise information processing apparatus 1. Furthermore, the above-mentioned program can be previously stored in a disk device included in a server apparatus on a network such as the Internet and can be allowed to be, for example, downloaded to a computer. Moreover, the above-described functions can be implemented by a cooperation between an operating system (OS) and application software. In this case, a program other than the OS can be previously stored in a medium and the medium can be distributed, or a portion other than the OS can be previously stored in a server apparatus and can be allowed to be, for example, downloaded to a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a printing unit configured to perform printing on a sheet;
an outlet through which the sheet is discharged;
a sheet conveyance path on which the sheet is conveyed through the printing unit and to the outlet;
a movable device located on the sheet conveyance path upstream of the outlet in a sheet conveying direction and configured to move between:
a separation position in which the sheet causes the movable device to be separated, by more than a predetermined threshold distance, from a conveyance surface on a side of the sheet conveyance path opposite of the movable device,
a proximity position in which the sheet conveyed on the conveyance path causes the movable device to be within the predetermined threshold distance from the conveyance surface, and
a protruding position in which apart of the movable device protrudes beyond the conveyance surface toward an opposite side thereof when the sheet is not conveyed on the conveyance path at the position of the movable device;
a detection device configured to detect a position of the movable device; and
a controller configured to determine a conveyance abnormality of the sheet based on the position of the movable device detected by the detection device, and output a signal indicating the conveyance abnormality.

2. The printer according to claim 1, wherein
in a case that the movable device does not enter the proximity position after conveyance of the sheet is started, the controller determines that the conveyance abnormality has occurred.

3. The printer according to claim 1, wherein
in a case that the movable device is in the separation position, the controller determines that the conveyance abnormality has occurred.

4. The printer according to claim 1, wherein
in a case that the movable device does not move to the proximity position from the protruding position after conveyance of the sheet is started or in a case that the movable device is in the separation state, the controller determines that the conveyance abnormality is occurring.

5. The printer according to claim 1, wherein
in a case that the movable device is in the proximity position after conveyance of the sheet is started, the controller determines that no conveyance abnormality has occurred.

6. The printer according to claim 1, wherein the movable device is positioned to face a non-recording region of the sheet on which the printing unit does not print.

7. The printer according to claim 6, wherein the non-recording region of the sheet is a surface of the sheet opposite of a surface of the sheet on which the printing unit prints.

8. The printer according to claim 6, wherein the non-recording region of the sheet is margin region present on a printing surface of the sheet.

9. The printer according to claim 1, wherein
the movable device rotates around an axis extending in a direction parallel to the conveyance surface and perpendicular to the conveyance direction of the sheet, and
the detection device is a photosensor that detects the state of the movable device according to whether light is blocked by the movable device.

10. The printer according to claim 1, wherein
the movable device linearly moves relative to the conveyance surface, and
the detection device is a photosensor that detects the state of the movable device according to whether light is blocked by the movable device.

11. The printer according to claim 1, wherein the controller is further configured to control conveyance of the sheet so that the conveyance of the sheet stops when the controller determines that the conveyance abnormality has occurred.

12. A merchandise information processing apparatus comprising:
a communication interface that receives transaction information;
a printing unit configured to perform printing on a sheet based on the transaction information;
an outlet through which the sheet is discharged;
a sheet conveyance path on which the sheet is conveyed through the printing unit and to the outlet;
a movable device located on the sheet conveyance path upstream of the outlet in a sheet conveying direction and configured to move between:
a separation position in which the sheet causes the movable device to be separated, by more than a predetermined threshold distance, from a conveyance surface on a side of the sheet conveyance path opposite of the movable device,
a proximity position in which the sheet conveyed on the conveyance path causes the movable device to be within the predetermined threshold distance from the conveyance surface, and
a protruding position in which a part of the movable device protrudes beyond the conveyance surface toward an opposite side thereof when the sheet is not conveyed on the conveyance path at the position of the movable device; and
a detection device configured to detect a position of the movable device; wherein
the controller is configured to determine a conveyance abnormality of the sheet based on the position of the movable device detected by the detection device, and output a signal indicating the conveyance abnormality.

13. The apparatus according to claim 12, wherein
in a case that the movable device does not enter the proximity position after conveyance of the sheet is started, the controller determines that the conveyance abnormality has occurred, in a case that the movable device is in the separation position, the controller determines that the conveyance abnormality has occurred, and
in a case that the movable device is in the proximity position after conveyance of the sheet is started, the controller determines that no conveyance abnormality has occurred.

14. The apparatus according to claim 12, wherein
in a case that the movable device does not move to the proximity position from the protruding position after conveyance of the sheet is started or in a case that the movable device is in the separation state, the controller determines that the conveyance abnormality is occurring.

15. The apparatus according to claim 12, wherein the movable device is positioned to face a non-recording region of the sheet on which the printing unit does not print.

16. The apparatus according to claim 15, wherein the non-recording region of the sheet is a surface of the sheet opposite of a surface of the sheet on which the printing unit prints.

17. The apparatus according to claim 15, wherein the non-recording region of the sheet is margin region present on a printing surface of the sheet.

18. The apparatus according to claim 12, wherein
the movable device rotates around an axis extending in a direction parallel to the conveyance surface and perpendicular to the conveyance direction of the sheet, and
the detection device is a photosensor that detects the state of the movable device according to whether light is blocked by the movable device.

19. The apparatus according to claim 12, wherein
the movable device linearly moves relative to the conveyance surface, and
the detection device is a photosensor that detects the state of the movable device according to whether light is blocked by the movable device.

20. The apparatus according to claim 12, wherein the controller is further configured to control conveyance of the sheet so that the conveyance of the sheet stops when the controller determines that the conveyance abnormality has occurred.
